(19) United States
(12) Patent Application Publication
(10) Pub. No.: US 2026/0059019 A1
(43) Pub. Date: Feb. 26, 2026

(54) SYSTEMS AND METHODS FOR AUTO DISCOVERY OF HYDRAULIC RELATED INFRASTRUCTURES

(71) Applicant: NETAFIM, LTD., Givatayim (IL)

(72) Inventor: Abraham Schweitzer, D.N. Hanegev (IL)

(73) Assignee: NETAFIM, LTD., Givatayim (IL)

(21) Appl. No.: 19/376,223

(22) Filed: Oct. 31, 2025

Related U.S. Application Data
(63) Continuation-in-part of application No. PCT/IL2024/050396, filed on Apr. 21, 2024.
(60) Provisional application No. 63/463,316, filed on May 2, 2023.

(51) Int. Cl. H04L 67/125

(52) U.S. Cl. CPC H04L 67/125

(57) ABSTRACT

An auto discovery (AD) protocol is provided for discovering within a communication network of an irrigation system how many hydraulic infrastructures were laid in a field. The AD protocol includes communicating within the communication network in a downstream direction messages that comprise each a Time to Live (TTL) field and determining based on responses that are received in the upstream direction the amount of hydraulic infrastructures that were laid in the field.

### RELATED APPLICATIONS

This is a Bypass Continuation-in-Part of PCT/IL2024/050396, filed Apr. 21, 2024 and published as WO 2024/228186A1. Priority is claimed to U.S. Provisional Patent Application No. 63/463,316 filed May 2, 2023. The contents of the above-mentioned applications are incorporated by reference in their entirety.

### TECHNICAL FIELD

Embodiments of the invention relate to systems and methods for auto discovery of hydraulic infrastructures, in particular to hydraulic infrastructures that are used in irrigation of crops and/or plants.

### BACKGROUND

Irrigation systems can be used for a variety of purposes, including crop production for increasing crop yields by ensuring that plants receive the right amount of water at the right time. Landscaping is another example where an irrigation system can be used to water lawns, gardens, and other types of landscaping.

Communication networks can be used in irrigation systems to monitor and control the delivery of water to plants and crops, in a manner which is often referred to as “smart” or “precision” irrigation.

Communication networks can be used in a variety of ways in irrigation systems, for example for transmitting sensor data to a man controller, for remotely controlling through a main computer an irrigation schedule (or the like).

Multi-hop routing is a technique used in communication networks to forward data packets from one node to another in order to reach their destination. In a multi-hop network, data is transmitted from a source node to a destination node through intermediate nodes, which act as relays.

The advantage of using multi-hop routing is that it enables communication in areas where a direct connection between any two given nodes is not possible or practical.

There are various mechanisms or concepts for monitoring failure of success of transmission of messages in a communication network, such as Time-To-Live (TTL), Timeout (etc.).

While timeouts and TTL are related concepts in networking, they are not the same thing and are normally used for different purposes.

Timeouts are used to specify the length of time that a device or system will wait for a response before considering a request or message as failed. Timeouts can be set for a variety of network operations, such as connecting to a server, sending a message, or receiving a response.

TTL, on the other hand, is used to limit the lifespan of a data packet in a network. The TTL field in an IP packet header specifies the maximum number of routes or hops that the packet can travel before being discarded. This prevents packets from circulating endlessly in a network and helps ensure efficient and reliable delivery of data.

While timeouts and TTL are not directly related, they can both affect the performance and reliability of network communication. By setting appropriate timeouts, network administrators can prevent delays and ensure timely responses to requests, while by setting appropriate TTL values, they can prevent network congestion and ensure that data packets are delivered efficiently.

### SUMMARY

The following embodiments and aspects thereof are described and illustrated in conjunction with systems, tools and methods which are meant to be exemplary and illustrative, not limiting in scope.

In an aspect of the present invention there is provided an auto discovery (AD) protocol for discovering within a communication network of an irrigation system, how many hydraulic infrastructures relating to the irrigation system were laid in a field.

In at least certain embodiments, the AD protocol comprises communicating within the communication network in a downstream direction messages that comprise each a Time to Live (TTL) field and determining based on responses that are received in the upstream direction the amount of hydraulic infrastructures that were laid in the field

In addition to the exemplary aspects and embodiments described above, further aspects and embodiments will become apparent by reference to the figures and by study of the following detailed descriptions.

### BRIEF DESCRIPTION OF THE FIGURES

Exemplary embodiments are illustrated in referenced figures. It is intended that the embodiments and figures disclosed herein are to be considered illustrative, rather than restrictive. The invention, however, both as to organization and method of operation, together with objects, features, and advantages thereof, may best be understood by reference to the following detailed description when read with the accompanying figures, in which:

FIG. 1 schematically shows an irrigation system with a communication network in accordance with an embodiment of the present invention; and

FIG. 2 schematically shows an example of a communication network within an irrigation block of the irrigation system of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated within the figures to indicate like elements.

### DETAILED DESCRIPTION

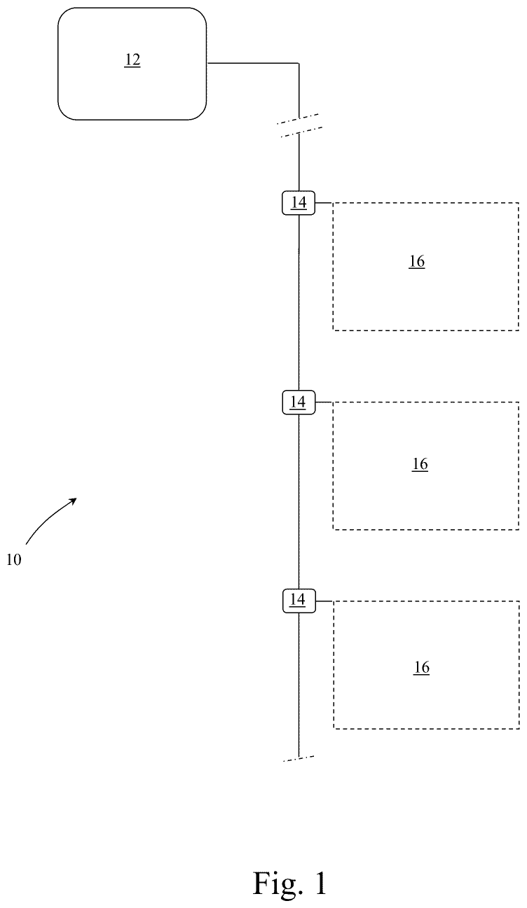

Attention is first drawn to FIG. 1 schematically showing a communication network 10 in accordance with an embodiment of the present invention here being implemented in an irrigation system.

Communication network 10 in this example can be seen including a main controller 12 and several network bridges 14 (here three being shown) for communicating between the main controller and hydraulic infrastructure located within each irrigation block 16 of the irrigation system.

The network bridges 14 may be generally close to the irrigation blocks 16, while the main controller 12 may not necessarily be close to the network bridges 14 and irrigation blocks 16.

Main controller 12 may be connected to the network bridges 14 via various communication channels, such as Glass fiber optics, wireless communication (etc.)—to form a data link layer (Layer ‘2’) protocol that provides substantially reliable communication between these two network devices 12 and 14.

The network bridges 14 communicate between the data link layer (Layer 2) and network segments at layers ‘1’ and possibly ‘0’ (zero) within the irrigation blocks 16 by forwarding data packets between these network segments of Layer ‘2’ and ‘1’ and possibly ‘0’.

Each network bridge 14 may be connected to the hydraulic infrastructure within its associated irrigation block 16 via fiber optics. In the example discussed where the communication network 10 may be implemented in an irrigation system, for reason of practicality the fiber optics may optionally be plastic fiber optics.

Such fiber optics may be used for connecting between each pair of a network bridge 14 and its associated irrigation block 16, and for communicating back and forth (respectively upstream and downstream) between the hydraulic infrastructures located within each irrigation block 16.

Reasons of practicality for choosing plastic fiber optics may for example be related to cost, manufacturing considerations (and the like). Since irrigation systems have low margins, the lower costs of plastic fibers may be appealing and plastic based fiber optics may in some cases be more suitable for manufacturing together with plastic based pipes of an irrigation system.

Once setting up a communication network in an irrigation system as discussed, an initial step prior to starting to use the communication network for controlling the irrigation system-may include discovering network components that were placed in the field, and in particular the hydraulic infrastructures that were laid down in the field. Preferably, such discovery of the network components may be performed in an automatic manner.

Detecting network components within the data link layer (Layer 2), such as the network bridges 14, may be performed via various protocols, such as the UDP (User Datagram Protocol). Possibly, the result of this stage may be detecting the address of each network bridge 14 so that it can be used during operation of the communication network to distinguish one network bridge from another.

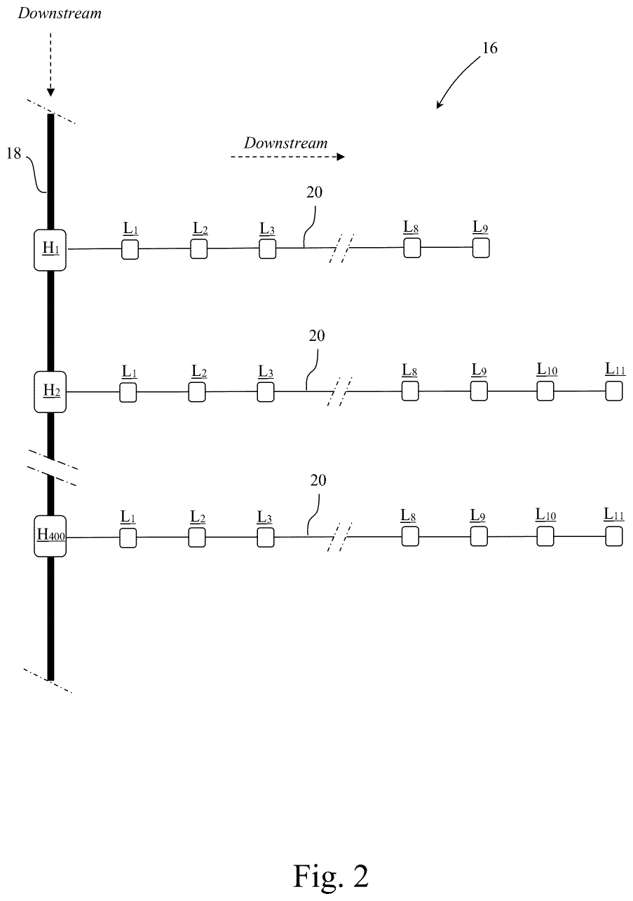

Attention is now drawn to FIG. 2 to describe an auto discovery (AD) stage in accordance with various embodiments of the present invention of hydraulic infrastructures of an irrigation block 16 that were laid in a field.

The hydraulic infrastructures seen in irrigation block 16 in this example include header nodes Hᵢ and lateral nodes Lᵢ, where the communication layer of the header nodes Hᵢ is considered as a layer 1 of the communication network and the communication layer of the lateral nodes Lᵢ is considered as a layer 0 (zero) of the communication network.

The header nodes are labeled by an alphanumeric designation comprising the letter “H” followed by an indexed letter “i” that indicates their respective location along a header pipe 18 of the irrigation block in a direction forth and away and downstream from the network bridge 14 of the irrigation block.

The lateral nodes are accordingly labeled by an alphanumeric designation comprising the letter “L” followed by an indexed letter “i” that indicates their respective location along a lateral pipe 20 that branches away from the header pipe 18 at each one of the header nodes in a downstream direction away from header pipe 18.

It is noted that the directional terms “downstream” and “upstream” define respective directions of transfer of communication messages within communication network 10—away and towards main controller 12. In the example of a communication network that is implemented in an irrigation system, these “downstream” and “upstream” directions may coincide with respective downstream and upstream flow directions of water/liquid within the irrigation system.

It is noted in addition that in certain embodiments, an irrigation block 16 may not necessarily include all or some of the hydraulic infrastructures exemplified in FIG. 2. For example, an irrigation block upon which an auto discovery (AD) stage of the present invention may be executed within the communication network 10 may only include a layer ‘1’ of communication of the header nodes Hᵢ or other hydraulic infrastructures suitable for use in an irrigation system.

In an embodiment, an auto discovery (AD) stage may comprise using in combination Time to Live (TTL) and Timeout characteristics.

A controller of the communication network, such as the main controller 12 or a block controller associated with each irrigation block 16—may initiate an AD stage of hydraulic infrastructure within a given irrigation block by sending AD communications within the given irrigation block. In cases where the controller managing the AD stage (e.g., the block controller) is positioned upstream, beyond the network bridge (i.e., toward the main controller), the AD communications may be transmitted back and forth via the network bridge 14 associated with the given irrigation block.

The AD communication may include first discovering the hydraulic infrastructures laid in communication layer ‘1’ of the irrigation block and afterwards in case of existence of hydraulic infrastructures in a communication layer ‘0’—also those hydraulic infrastructures.

Discovery of the hydraulic infrastructures existing in layer ‘1’ may be accomplished using a Time to Live (TTL) field in the communication protocol of the AD. The controller managing the auto discovery stage may transmit downstream towards an irrigation block 16 a transmission with various numbers of hops that the packet can travel in the header of the TTL, and according to the returning upstream packets the controller may discover how many hydraulic infrastructures (e.g. header nodes) exist layer ‘1’ of the irrigation block.

The AD protocol may include also timeouts to assist in the identification of how many hydraulic infrastructures are present in layer ‘1’. A timeout may be used by specifying the length of time to wait for a response from a potential hydraulic infrastructure that was queried if present, an ‘X’ number of hops within layer ‘1’ (by defining the TTL with the number ‘X’ in its header).

For example, if only ‘5’ hydraulic infrastructures were laid in a field in layer ‘1’ and the AD protocol sent a TTL downstream with the number ‘6’, the timeout will assist in determining that the request for the return message has failed and that there are less than ‘6’ hydraulic infrastructures in the layer.

If on the other hand, a hydraulic infrastructure ‘6’ hops within layer ‘1’ exists, an AD protocol sent downstream with the number ‘6’ in its TTL will result in a returning message that is sent back upstream from the hydraulic infrastructure confirming its existence and hence its discovery.

After completing discovery of all the hydraulic infrastructures (in this example header nodes) within layer ‘1’, and e.g., in the case that further hydraulic infrastructures are known to be potentially present layer ‘0’, the controller may also extend the auto discovery (AD) stage to layer ‘0’.

The controller transmits downstream towards each one of the hydraulic infrastructures (here header nodes) in layer ‘1’ of the irrigation block 16—a transmission with various numbers of hops that the packet can travel defined in the TTL, however this time towards the lateral nodes Lᵢ along a lateral pipe 20.

In a similar way as described above with respect to the detection of hydraulic infrastructures within layer ‘1’, the auto discovery (AD) protocol can discover the number of nodes along each lateral pipe 20 to complete a full discovery of the hydraulic infrastructures that were laid in the field—so that the communication network 10 can be in a state that is ready to control irrigation within the irrigation system.

Irrigation systems are typically designed prior to field installation; however, the actual layout implemented in the field may deviate from the planned design due to on-site considerations—for example, when the topography intended for irrigation is found to be unsuitable during the physical installation of the system.

Consequently, the expected amount of hydraulic infrastructure within an irrigation block where the AD stage is performed is generally known in advance, albeit with a certain degree of uncertainty.

By way of a non-limiting example, the number of header nodes Hᵢ within an irrigation block 16 may be approximately 60 or more (e.g., 120, 160, or even up to 400 header nodes or more). Similarly, the number of lateral nodes Lᵢ (if present along the lateral pipes 20) may be around 10, 11, 12, or similar values.

Since the expected amount of hydraulic infrastructure in a given field is generally known in advance, an aspect of the present invention provides techniques for more efficiently determining the actual amount of infrastructure that has been actually installed.

For example, in conventional techniques, the TTL (Time-To-Live) value is incremented by one at each iteration (i.e., 1, 2, 3, . . . ) to progressively explore an unknown communication infrastructure. This approach is useful when the general outline of the explored network is unknown.

However, in irrigation systems, the approximate layout is generally known in advance. Therefore, in accordance with the present disclosure, the TTL may initially be set to a value greater than “1” (one) and then adjusted upward or downward depending on whether the destination hydraulic infrastructure being queried is reached. This approach greatly reduces the number of required probes, latency, and communication overhead compared to the conventional linear method.

By way of a non-limiting example, the TTL values used in the initial and subsequent steps of discovering the actual layout of the hydraulic infrastructure of an irrigation system installed in a field may be determined using any of the following search strategies: Binary, Interpolation, Exponential, Fibonacci, or similar search methods.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Further more, while the present application or technology has been illustrated and described in detail in the drawings and foregoing description, such illustration and description are to be considered illustrative or exemplary and non-restrictive; the technology is thus not limited to the disclosed embodiments. Variations to the disclosed embodiments can be understood and effected by those skilled in the art and practicing the claimed technology, from a study of the drawings, the technology, and the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures can not be used to advantage.

The present technology is also understood to encompass the exact terms, features, numerical values or ranges etc., if in here such terms, features, numerical values or ranges etc. are referred to in connection with terms such as “about, ca., substantially, generally, at least” etc. In other words, “about 3” shall also comprise “3” or “substantially perpendicular” shall also comprise “perpendicular”. Any reference signs in the claims should not be considered as limiting the scope.

Although the present embodiments have been described to a certain degree of particularity, it should be understood that various alterations and modifications could be made without departing from the scope of the invention as hereinafter claimed.

1. An auto discovery (AD) protocol for discovering within a communication network of an irrigation system, an amount of hydraulic infrastructures relating to the irrigation system laid in a field, the AD protocol comprises:
communicating within the communication network in a downstream direction messages that each comprise a Time to Live (TTL) field; and
determining based on responses that are received in the upstream direction the amount of hydraulic infrastructures laid in the field.

2. The AD protocol according to claim 1, wherein the Time to Live (TTL) field is in a header of each message.

3. The AD protocol according to claim 1, wherein each message comprises a number ‘N’ of hops in the Time to Live (TTL) field that it can travel in the downstream direction.

4. The AD protocol according to claim 2, further comprising timeouts for assisting in the discovery of how many hydraulic infrastructures were laid in the field.

5. The AD protocol according to claim 4, wherein the timeout determines the length of time to wait for an upstream arriving response from a certain hydraulic infrastructure that was queried if present in a downstream given message according to the Time to Live (TTL) field of the given message.

6. The AD protocol according to claim 5, wherein communicating messages downstream within the communication network is in a direction away from a controller managing the auto discovery (AD) protocol.

7. The AD protocol according to claim 6, wherein the determining of the amount of hydraulic infrastructures that were laid in the field comprises receiving upstream responses at the controller.

8. The AD protocol according to claim 7, wherein the communication network comprises several layers, and the determining of the amount of hydraulic infrastructures that were laid in the field comprises first discovering hydraulic infrastructures in a certain layer prior to discovering hydraulic infrastructures in a further layer that is downstream to the first layer.

9. The AD protocol according to claim 3, wherein the Time to Live (TTL) field is initially set to an initial starting value of ‘N’ that is greater than “1” (one) and then adjusted upward or downward depending on whether the destination hydraulic infrastructure being queried is reached.

10. The AD protocol according to claim 9, wherein the initial Time to Live (TTL) field value of ‘N’ is set based on the total number of hydraulic infrastructures (TNH) of the irrigation system that were planned for installation in the field and are currently being discovered.

11. The AD protocol according to claim 9, wherein the initial Time to Live (TTL) field value of ‘N’ is TNH divided by two according to a binary search strategy.

12. A method for discovering within a communication network of an irrigation system, an amount of hydraulic infrastructures relating to the irrigation system laid in a field, and comprising:
communicating within the communication network in a downstream direction messages that comprise each a Time to Live (TTL) field, and
determining based on responses that are received in the upstream direction the amount of hydraulic infrastructures that were laid in the field.

13. The method of claim 12, wherein the Time to Live (TTL) field is in a header of each message.

14. The method of claim 12, wherein each message comprises a number ‘N’ of hops in the Time to Live (TTL) field that it can travel in the downstream direction.

15. The method of claim 12, further comprising assisting in the discovery of how many hydraulic infrastructures were laid in the field with timeouts.

16. The method of claim 15, wherein a timeout determines the length of time to wait for an upstream arriving response from a certain hydraulic infrastructure that was queried if present in a downstream given message according to the Time to Live (TTL) field of the given message.

17. The method of claim 16, wherein communicating messages downstream within the communication network is in a direction away from a controller managing the discovery.

18. The method of claim 17, wherein the determining of the amount of hydraulic infrastructures that were laid in the field comprises receiving upstream responses at the controller.

19. The method of claim 18, wherein the communication network comprises several layers, and the determining of the amount of hydraulic infrastructures that were laid in the field comprises first discovering hydraulic infrastructures in a certain layer prior to discovering hydraulic infrastructures in a further layer that is downstream to the first layer.

20. The method of claim 14, wherein the Time to Live (TTL) field is initially set to an initial starting value of ‘N’ that is greater than “1” (one) and then adjusted upward or downward depending on whether the destination hydraulic infrastructure being queried is reached.
